(19) United States
(12) Patent Application Publication
(10) Pub. No.: US 2005/0176496 A1
(43) Pub. Date: Aug. 11, 2005

(54) Hotwalker showdown racing game

(75) Inventor: Andrew Stronach, Aurora (CA)

Correspondence Address: Mark A. Litman & Associates, P.A.;York Business Center, Suite 205, 3209 West 76th St., Edina, MN, 55435, US

(73) Assignee: ASIP Holdings, Inc.

(21) Appl. No.: 10/895,451

(22) Filed: Sep. 15, 2003

(51) Int. Cl. A63F 13/00

(52) U.S. Cl. 463/25

(57) ABSTRACT

A method of providing a wagering event comprises a player paying for at least one wager on a race event selected from the group consisting of a) a player selected wager and b) an automatically handicapped and selected wager. The player also receives on the race event c) an automatically handicapped and selected wager when a) is selected or d) a player selected wager when b) is selected, the combination of selections a) and c) and selections b) and d) forming a special event wager. After results of the race event are final, the player has the potential to receive an award dependent upon predetermined criteria having been met in results of the race event with respect to the special event wager. The criteria may require that at least one of a) a player selected wager and b) an automatically handicapped and selected wager be winning events in the race event results.

### BACKGROUND OF THE INVENTION

1. Field of the Invention

The present invention relates to race event wagering, particularly pari-mutuel race event wagering, and to competitive race wagers on pari-mutuel race events.

2. Background of the Art

Wagering on race events, such as horse races and dog races, typically takes the form of either fixed odds wagering or the more common pari-mutuel wagering. Fixed odds wagering is a system by which the return for a particular wager is determined in accordance with the payout odds assigned to the associated bet. Fixed odds wagering is popular from the perspective of wager recipients (e.g., betting parlors) since it places a limit on the magnitude of the payout in the event of a win. Fixed odds wagering is also popular from the perspective of players since it provides a measure of certainty on the possible payout.

Pari-mutuel wagering is a system by which a wagering pool is established for the receipt of bets, and the proceeds of the pool are divided amongst holders of winning wagers in accordance with the number and types of winning wagers and the magnitude of each wager. Pari-mutuel wagering is popular from the perspective of the wager recipients (e.g., race track owners), since the recipient typically receives a fixed percentage of the pool prior to the payout to the winning wager holders. Also, pari-mutuel wagering is popular from the perspective of the person making the wager since the return on a particular wager is proportional to the size of the wagering pool and, therefore, can exceed the fixed odds return of the bet. However, pari-mutuel wagering also suffers from a number of disadvantages.

Firstly, pari-mutuel wagering often requires detailed knowledge of betting terminology (e.g., win, place, show, exacta, triacta, etc. wager types). Secondly, pari-mutuel wagering often requires the wageror to be conversant with betting forms, and to have knowledge of race contestant handicapping. For example, for horse racing, successful handicapping requires a consideration of several factors, including track conditions, horse record, and jockey record for each contestant horse. Consequently, pari-mutuel wagering may not provide wager recipients with a significant return since novices may be intimidated by the knowledge required and either make only minimal wagers or no wagers at all.

Therefore, attempts have been made to improve on the conventional pari-mutuel wagering systems to encourage wagering. For instance, AmTote International, Inc. markets video terminals which remove the need for a player to interact with a human wager recipient. The video terminal consists of a touch-sensitive CRT display, a card reader, and a central processing unit in communication with the CRT display, the card reader and a remote wagering computer for processing desired wagers. To place a wager, the player purchases a wager card, inserts the wager card into the card reader, and then selects the desired track, the desired horse(s), the wager type (e.g., win, place, show, exacta, triacta, etc.), and the amount of the wager. Although the video terminal allows the novice to conceal to a very limited extent his/her lack of familiarity with betting terminology and handicapping, it does little to encourage the novice to make wagers. Additionally, it would be desirable and enhance entertainment for advanced players.

U.S. patent application Ser. No. 09/997,288, filed Nov. 30, 2001, which application is incorporated herein by reference in its entirety, describes an automated wagering terminal that places wagers on pari-mutuel events based on handicapping algorithms and analysis of handicapping data and odds data (e.g., published odds data, track odds data, etc.). That system is quite efficient, but it would be desirable to provide a mechanism for attracting players to the use of the terminals to increase the operation utilization of the automated terminal.

### SUMMARY OF THE INVENTION

The present invention relates to a capability of providing tabulations or identifications of non-entered automatically generated wagers to players before conclusion of race events so that individual performance of players can be compared on a race event-by-race event basis to individual player's (handicapper's) performance. A wagering terminal itself or floor walker with electronic (e.g., RF) access to an automated wagering source (performed with handicapping function) can provide a non-cashable ticket providing a player with information on how the automated system would have selected a contestant in a specific race. The non-cashable ticket may be specifically coded or colored to assure that it cannot be accidentally cashed as a winning ticket, or may be in a format that is distinct from track wagering tickets and can only be read or cashed by a like terminal. A special wagering event can be practiced whereby if a player makes an individual selection and also makes an automated selection, a bonus will be given the player if the player selection wins more money than the automated selection and/or the individual player selection horse finishes ahead of the automated selection horse and both horses are winners.

### DETAILED DESCRIPTION OF THE INVENTION

A player (one who places a wager) at a race event ordinarily will attempt to use individual skills, knowledge and techniques to select a wager on a race contestant to win the wager. The player will use all of the available information that players ordinarily use or believe will assist in selecting a best wager on a particular race. Players have a high degree of confidence in their handicapping skills, and are very competitive against other players. The present game and method enables the player to actually compete with an automated handicapping system, with little or no expense, and add more competitive interest to the wagering.

The player must have access to an automatic wagering system that bases candidate selection on a handicapping system (e.g., algorithms and software implemented by a processor. Such an automated handicapping, race contestant selection system is described in U.S. patent application Ser. No. 09/997,288, filed Nov. 30, 2001 (hereinafter referred to as the “Stronach Application”), which application is incorporated herein by reference in its entirety. Handicapping may be based upon any form of information, including, but not limited to those forms of information described in the Stronach Application, such as past race results, changes in training, jockey results, changes in jockey or trainer, bullet times, changes in competition level, weight changes, changes in odds (e.g., from morning odds to near-post time odds), track conditions, late wagering, and other publicly available information. The automated wagering system may be a dedicated automated wagering terminal, a mixed individual selection and automated terminal, or personnel that have access to the automated system (e.g., a floor walker with RF access or other electronic access to an automated contestant selection system relying at least in part on handicapping selections).

The object of the method is as follows. The player may be able to receive either a active automated wager or an inactive automated wager, in addition to an individual active or inactive wager placed by the player. By active is meant that the ticket is a recognition of an actual wager on a specific event or specific contestant (e.g., a single contestant for win, place or show, and an event such as exacta, triacta, trifecta, perfecta, daily double, etc. where multiple contestant selection is required) and that the ticket may be cashed in when the selection identified on the ticket is a winning selection. Inactive means that the selection identified on the ticket cannot be cashed in, irrespective of the results of the race, yet identifies a specific wager.

The options of the player are as follows: a) the player may make an independently handicapped or random active wager on a contestant(s) in a racing event (on one or more races, as in a trifecta or daily double respectively); b) the player may elect to have the terminal and intelligence system associated therewith make an automated selection of a active wager on a contestant(s); c) the player may make both an independently handicapped (or random) active wager and an automated handicapped active wager on a contestant(s) in a racing event; d) after having performed a) or in conjunction with a), the player may make an inactive wager with the automated handicapping selection system with a special wagering relationship established between the a) pick and the d) pick; e) after having performed b) or in conjunction with b), the player may make an inactive wager with individual player handicapping and selection with a special wagering relationship established between the b) pick and the e) pick; or after, during or before having performed c), the player may elect to have a special wagering relationship established on any recordation of the wagers between the two active wagers. The term special “wagering relationship” means a comparison between the success of the two wagers, specifically where the comparison is based on at least one or more parameters selected from the group consisting of which of the two wagers produced or (in the case of inactive wagers) would have produced at least one of a higher finishing contestant(s), a higher finishing set of contestants, a higher payout on the same wager amount, and the like. The special relationship may be limited in application to circumstances where both the automated selection and individual selection both finish in the money for the particular wager, or where only the individual selection finishes in the money. The special relationship play may have gaming or wagering benefits to the player. For example, the provision of a ticket on a non-active wager to a player making individually handicapped selections may be issued on a ticket fixed to (e.g., on the same ticket) or data connected to the individually handicapped ticket. That is, the automated ticket will have a unique wagering relationship to the specific individual ticket provided to the player on the individual wager. The automated wager ticket selection may be provided on a gratis basis to a player in a promotional environment to stimulate use of the automated system. The automated ticket will be given to the player and the player will examine the automated ticket at the conclusion of the race event and determine which selection proved to be the best. In the promotional event, if the player selection outperformed the automated selection based on established criteria, then the player might be comped or rewarded with a percentage of the original player wager, such as 0.5%, 1.0%, 1.5%, 2.0%, 2.5%, 3.0%, 3.5%, 4.0%, 4.5%, 5.5% or more of the original wager. Even in a non-promotional mode, the race tracks can absorb this percentage to stimulate additional wagering. The results of the wagers will be compared at the conclusion of the race event and the tickets (automated versus individually handicapped) and the player will gain an appreciation for the success of the automatic handicapping system. This may at least promote use of the automated handicapping system, if not additional play in the special relationship wagering (SRW).

In the practice of SRW, another wagering format would be where the player makes an individually handicapped active wager, and at no additional cost or at a marginal additional cost, has the automated handicapping system identify an automated selection on the same race event, preferably on the same ticket or else on a ticket unique to the individual wager (as later explained in greater detail). If the player “wins” under the established criteria against the automated wager, the player will receive an additional award (above the return on a winning wager) that exceeds the marginal amount wagered (any return would exceed a free wager). For example, if the individually handicapped wager is for a Place bet, and the criteria for a winning event is that the individually handicapped contestant must finish at least 1^{st} or 2^{nd} and the automated handicap selection must finish at least 2^{nd} or 3^{rd}, an additional $1.00 wager on that special relationship event may pay off at 5:1 odds. That payout has the possibility of exceeding the return on the primary Place wager if the selection is a prohibitive favorite. Ties would be a push in the event that the individual selection and the handicapped selection were the same contestant(s) or if the criteria were that the payout for the individual selection must exceed the payout for the automated handicapped selection. For example, if the individual selection were for a Win bet on a contestant going off at 1:2 odds and the automated selection were for a Place bet on a contestant going off at 8:1 odds, if both wagers won, the automated place bet would pay more, and the special relationship wager could be either a loss (of the $1.00 special event wager) or a push, with the $1.00 special event wager credited to or collectable by the player.

The special event wager may also be played the player making both an individually handicapped active wager and an automated active wager that are both printed on the same ticket. Again, there might or might not be any additional wagering cost for the special relationship wager, especially where both are active wagers and the player has made two wagers on the same race event.

The race providing system generally manages and processes various racing information, particularly wagering information associated with race events held at various race event tracks. An example race providing system is Amtote International, Inc.'s totalisator system which processes racing information from or related to not only race events at which Amtote provides wagering transaction services but also race events unassociated with Amtote but for which racing information is provided through the Amtote totalisator system (e.g., racing information from or related to simulcast race events). The racing information may include race event information, such as the names and start positions of the race contestants (e.g., horses, dogs) running in each race event for which the race providing system has information, the distance of each such race event, the race event track name of each such race event, the start time of each such race event, etc. The racing information may also include odds information for each race contestant, betting pool information on the betting pool associated with each race event, handicapping information, such as the weather conditions, and the jockey name, race contestant age, win record, and number of days since the last race event for each race contestant, and/or race result information such as the race results at the end of each race event. The racing information may be any combination of the race event information, odds information, betting pool information, handicapping information, race result information and/or other information as needed for the effective operation of the at least one wagering terminal. Optionally, the racing information may also include audio and video data corresponding to some or all of the race events for which the race providing system has information.

In a typical race providing system, the racing information is generated internally within the race providing system and/or obtained from associated race event tracks and, if applicable, off-track betting locations/devices and other race providing systems. A race providing system may also receive racing information from an information provider, unassociated with a particular race event track, supplying racing information (e.g., information services provided by Equibase Company LLC). Further, the at least one wagering terminal provides racing information to the race providing system, particularly betting pool information. In an embodiment, the race providing system includes information related to a number of race events at one or more race event tracks so as to provide the at least one wagering terminal with information regarding a substantially continuous succession of race events. As will be apparent to those skilled in the art, each race event track or other information provider may instead of or in addition to providing their racing information to or through the intermediate race providing system, provide the racing information directly to the at least one wagering terminal over a connection or network. However, in an embodiment, a race providing system is used.

In another embodiment, the race providing system may comprise a system operator interface, a wagering terminal transceiver for communicating with the at least one wagering terminal, a central processing unit (CPU) 220 in communication with the system operator interface and the wagering terminal transceiver, and memory in communication with the CPU.

The system operator interface comprises a data display device, typically comprising at least one CRT display (although falt screen, plasma screens, LED screen, LCD screens and the like may be used for any display system used in the practice of the invention), for allowing a system operator to view, among other things, the racing information. The system operator interface also includes a data input device, such as a touch screen, button panel, keyboard and/or mouse, for allowing the system operator to enter control commands through the system operator interface. The control commands include commands for configuring racing information to be transmitted to the at least one wagering terminal, commands for configuring the wager processing of the race providing system, and where applicable, commands for configuring the wager type of the at least one wagering terminal.

The wagering terminal transceiver for communicating with the at least one wagering terminal is one or more mechanisms to send all or some of the racing information to the at least one wagering terminal and, where applicable, to send any other information to the at least one wagering terminal. The wagering terminal transceiver for communicating with the at least one wagering terminal is also configured to receive wagering information from the at least one wagering terminal for provision to the wagering processor. Such mechanisms may be typical communication interfaces. In an embodiment, the racing information is manipulated and formatted for sending to the at least one wagering terminal. Further, the other information sent to the at least one wagering terminal may include one or more sets of quick pick race contestant(s) and one or more least chosen race contestants for a wager type, particularly the one or more race contestants for a wager type that may yield a payout of the entire pool, both as described in more detail below.

The memory includes processor instructions for the CPU to define a quick pick race contestant(s) selector and a wager processor. The memory also includes a wager database in communication with the wager processor. As will be apparent to those skilled in the art, the memory may be non-volatile or volatile (e.g., RAM) memory or both. The wager database includes one or more wagering records that identify the network address of the at least one wagering terminal from which a wager has been placed and information regarding the wager transmitted from that at least one wagering terminal.

The wager processor is configured to receive wager information from the at least one wagering terminal (typically via the wagering terminal transceiver), to maintain the wager database with the received wager information and where applicable, to signal the appropriate at least one wagering terminal to initiate payout of winning wagers to the user of the at least one wagering terminal. Where the at least one wagering terminal is used to place pari-mutuel wagers, the wager processor is also configured to include the received wager information into the appropriate pari-mutuel pool and where applicable, obtain information on the size of the parimutuel pool for calculation of the relevant payout. Where, for example, the race providing system is connected to one or more other race providing systems, the wager processor transfers the received wager, where applicable, to the correct race providing system(s) so that the wager can be included in the appropriate parimutuel pool managed by that race providing system(s) and similarly, where applicable, obtain information on the size of the parimutuel pool from the relevant race providing system(s) for calculation of the relevant payout.

The quick pick race contestant(s) selector is used to generate one or more sets of quick pick race contestant(s) for each race event. Each set of quick pick race contestant(s) comprises one or more race contestants of a race event according to a specific wager type and is determined by a race contestant selection algorithm. The number of determined race contestants in a set of quick pick race contestant(s) primarily depends on the wager type. A set of quick pick race contestant(s) for a win, show or place wager type will comprise one race contestant. Similarly, a set of quick pick race contestant(s) for an exacta wager type will comprise two race contestants.

The race contestant selection algorithm(s) employs handicapping information and odds information to determine a set of race contestants for a particular race event according to a specific wager type. In an embodiment pertaining to horse racing, the algorithm analyzes for each race contestant of a particular race event the handicapping information including without limitation the race contestant's trainer statistics, race contestant's jockey statistics, the track condition of the race event, and the times between race events for the race contestant. Further, the algorithm analyzes for each race contestant of a particular race event the odds information, for example the difference between the “morning line” odds and current odds information for the race contestant. The quick pick value of each race contestant may then simply be a weighted value of the handicapping information and odds information associated with each race contestant. The quick pick values for the race contestants of a race event are then analyzed to determine a set of race contestants for a specific wager type for the particular race event, preferably an optimal set of race contestants to win the specific wager type for the particular race event. As will be apparent to those skilled in the art, any number of race contestant selection algorithms are possible employing handicapping information and odds information to determine a set of race contestants for a specific wager type for a particular race event.

The quick pick race contestant(s) selector may also be implemented on the at least one wagering terminal in addition to or substitute of the quick pick race contestant(s) selector provided at the race providing system. Further, the quick pick race contestant(s) selector can determine the one or more sets of quick pick race contestant(s) automatically for each race event and/or determine the one or more sets of quick pick race contestant(s) for a race event upon request from or at the at least one wagering terminal. The race event selector communicates with the racing information buffer and the wagering processor. The race event selector is configured to select race event information received from the race providing system for presentation on the display. In an embodiment, the race event selector is configured to determine and make available for display information about a next race event which is scheduled to run at all or certain of the race event tracks for which the race providing system has supplied race event information. The race event selector is also configured to determine and make available for display future race events in time order at all or certain of the race event tracks for which the race providing system has supplied race event information. If more than one race event is scheduled to run at or about the same time, the race event selector selects information about one of the race events for display (for example, choosing a race event at a more preferred race event track). In this manner, the at least one wagering terminal may continuously provide a succession of race events to a user upon which to wager. As will be appreciated, some race events can only entertain certain types of wagers. For instance, superfecta wagering may not be permitted at a certain race event. Consequently, the race event selector may select for display only those race events for which the at least one wagering terminal is configured to receive wagers.

Further, the race event selector is configured to accept a next or previous race selection command from the user interface via the wagering processor, thereby allowing the user to view information regarding a next race event or future race events. For example, the user may “scroll” back and forth through a next and other future race events by starting time by touching the “Next Race” and “Previous Race” buttons/icons, each touch of the buttons/icons causing the wagering processor to present, as applicable, updated information on the display corresponding to the “previous” or “next” race event by start time. Essentially, the user is able to view (and thus wager on) in time order a next race event and other future race events for which the at least one wagering terminal has information. In an embodiment, a next and other future race events by starting time may be the next race events by starting time found at all of the race event tracks for which the race providing system has supplied race event information. In another embodiment, a next and other future race events by starting time may be the next and other future race events at the certain current race event track which is presented on the display of the at least one wagering terminal.

The race event selector is also configured to determine and make available for display race events at different race event tracks. In this regard, the race event selector is configured to accept a next or previous race event track selection command from the user interface via the wagering processor, thereby allowing the user to view information regarding a race event at different race event tracks. For example, the user may “scroll” through future race events at different race event tracks by touching the “Next Track” and “Previous Track” buttons/icons, each touch of the button/icons causing the wagering processor to present, as applicable, updated information on the display corresponding to the future race events at “previous” or “next” race event tracks. Essentially, the user is able to view (and thus wager on) race events at different race event tracks for which the at least one wagering terminal has information. In an embodiment, the race event track (of all of the race event tracks for which the race providing system has supplied race event information) having the next starting race event is presented, along with that next race event, on the display of the at least one wagering terminal in response to a “next” race event track command. In another embodiment, the next race event track in alphabetical order (of all of the race event tracks for which the race providing system has supplied race event information) is presented, along with next starting race event at that race event track, on the display of the at least one wagering terminal in response to a “next” race event track command.

The account processor is in communication with the card read/write device, the account buffer and the wagering processor. The account processor is configured for crediting and debiting, in accordance with the amount wagered and the outcome of the elected race event, the balance of a user's account. For example, the account processor determines whether the user has introduced an electronic/magnetic-stripe card to the card read/write device, and then establishes an account for the user in the account buffer. The balance of the user's account may be stored, for example, on the electronic/magnetic-stripe card which is introduced to the card read/write device. Information about the amount wagered and the outcome of the elected race event is supplied by the wagering processor. The account processor performs basic checks to ensure that the user's account has a credit, that the account has enough credit for the amount wagered and that the card is otherwise operating properly. Information regarding some or all of these checks is communicated to the wagering processor in order to allow the wagering processor to submit a wager to the race providing system. In an embodiment, the account processor is also configured to request from the user an appropriate password or other identification information via the user interface before establishing the account for the user in the account buffer. In an embodiment, the electronic/magnetic-stripe card is specially designed and configured for the at least one wagering terminal. As will be apparent to those skilled in the art, other types of cards may be used such as credit and debit cards.

The wagering processor communicates with the quick pick race contestant(s) buffer, the racing information buffer and the account processor. The wagering processor is configured to display the race contestants of the displayed race event using the odds information stored in the racing information buffer. In an embodiment, race contestants are shown as differing shaded/color icons on the display depending on the odds information associated with the race contestants. A color palette may be provided on the at least one wagering terminal to identify the colors associated with the race contestants, namely colors ranging from favorite to longshot. In an embodiment, the color palette is provided physically on the glasswork of the housing of the at least one wagering terminal although as will be apparent to those skilled in the art, the color palette may also, for example, be provided on the display or as part of a payout table. For example, a horse icon for a favorite horse race contestant may be shown in blue while a horse icon for a lesser favorite horse race contestant may be shown in purple. In an embodiment of the at least one wagering terminal, each differing shaded/color icon is associated with a rate contestant based on the win odds associated with the race contestant. If two race contestants have the same win odds, then the amount wagered on the race contestant in the win pool (if available) is used to select the favorite. Otherwise, whichever race contestant has the lower number assignment will be considered more favorite. In another embodiment of the at least one wagering terminal, each differing shaded/color icon is associated with a race contestant based on the amount wagered on the race contestant. As will be apparent to those skilled in the art, any number of means of assigning one or more colors reflecting odds associated with a race contestant may be used.

The wagering processor may also be configured to display the potential estimated winning payout of a wager on one or more race contestants of a race event according to the wager type of or selected in the at least one wagering terminal. For example, a wagering terminal configured for or in which is selected, an exacta wager type may present on a display (e.g., a ticker-type display) a combination of race contestants (such as horse 5 and horse 3) of the race event about which information is shown on the display (e.g., a CRT or other display), that may yield a certain estimated winning payout (such as $10,000 if horse 5 and horse 3 finish in that order in first and second place). In an embodiment, the greatest potential estimated winning payout(s) (and associated race contestant(s) that need to be selected to win the estimated payout(s)) is displayed according to the wager type of or selected in the at least one wagering terminal and the race event displayed on the at least one wagering terminal. In another example, a wagering terminal configured for or in which is selected, a superfecta wheeler wager type may present on a display, the current pool total of the race event about which information is shown on the display, such that perhaps a certain unique winning wager combination of the superfecta wager type may yield a payout of the pool (“jackpot”).

The wagering processor is also configured to receive wager information from the user interface and for selecting one or more race contestants for the wager. For example, the wagering processor receives through the user interface an instruction for a wager amount, for an elected race event, which is transmitted to the race providing system together with the elected race contestants once the user instructs through the user interface the submission of the wager. In another embodiment, the at least one wagering terminal has buttons corresponding to certain wager amounts and/or combinations which when engaged by the user instruct the wagering processor the wager amount and/or combination and a play button which when engaged by the user instructs the wagering processor to submit the wager. In an embodiment, the wagering processor employs a default wager amount and/or combination, e.g., the lowest wager amount and/or the quick pick race contestants, when it is not instructed the wager amount and/or combination through the user interface but is instructed to submit the wager.

Through the user interface, the user also can manually select the one or more race contestants for a wager or select that a set of quick pick race contestant(s) as provided in the quick pick race contestant(s) buffer is used for the wager. As discussed below, the one or more sets of quick pick race contestant(s) may be supplied in a substantially continuous fashion to the wagering processor and/or as requested by the wagering processor (typically via the quick pick race contestant(s) buffer). In an embodiment, the user can manually select one or more race contestants for a wager by touching a touch-sensitive screen of the display or may select a set of quick pick race contestant(s) by pressing the “Play” button of the at least one wagering terminal. In an embodiment, the wagering processor employs one or more race contestants from a set of quick pick race contestant(s) to complete a wager if all the necessary race contestants for the wager type have not been selected but the wagering processor is instructed nevertheless to submit the wager. In this fashion, the wager will comprise the race contestant(s) selected by the user and one or more race contestant(s) from the quick pick race contestant(s) needed to complete the wager of the applicable wager type.

The wagering processor is also configured to show on the display the race contestants that have been manually elected by the user or the race contestants in a set of quick pick race contestant(s). For example, in an embodiment, the user selection of a race contestant on a touch-sensitive display causes an icon corresponding to the race contestant to change in appearance to indicate the race contestant has been selected. Similarly, the icons of quick pick race contestant(s) may change in appearance to indicate their selection.

The wagering processor is also configured to receive information regarding the sufficiency of credit in a user's account from the account processor and to provide the amount wagered and the outcome of the elected race event to the account processor for crediting and/or debiting a user's account.

The wagering processor may also be configured to provide a prize to a user upon the submission of a wager. For example, the submission of a wager may trigger, according to a prize selection algorithm, the provision of a prize to the user, for example, in the form of a credit of the user's account or a credit or other type of prize on a ticket provided from the ticket dispensing device. In an embodiment, the prize selection algorithm may simply be a random seed or else the prize selection algorithm may determine to provide a prize after every certain amount of wager submissions through the wagering terminal. In another embodiment, where the prize selection algorithm is implemented across the wagering system, the prize selection may determine to provide a prize to a particular wagering terminal after every certain amount of wager submissions through wagering terminals throughout the wagering system.

The wagering processor may also be configured to select one or more race contestants, according the applicable wager type, which represent the least chosen one or more race contestants for the wager type, particularly the one or more race contestants for the wager type that will yield a payout of the entire pool. Such selected race contestant(s) may determined using the odds information and/or betting pool information or may be provided by the race providing system. In an embodiment, a button (titled, for example, “Jackpot” button) is provided to allow the automatic selection of such one or more race contestants for a wager.

In a variation (not shown), the user interface includes a reselect button for initiating reselection of the race contestants, and the wagering processor is configured to reinitiate selection of race contestants upon receipt of the reselection command from the user interface. In this variation, the wagering processor is configured to issue a command to the race providing system to provide a one or more new sets of quick pick race contestant(s) and then to select from the one or more new sets of quick pick race contestant(s) provided by the race providing system. In this manner, the wagering processor typically selects different quick pick race contestant(s) for each actuation of the select button.

The details of the wagering process of an embodiment, as facilitated by the processing instructions of the wagering processor, are explained in greater detail below.

Turning now to another embodiment of the at least one wagering terminal may comprise a display for presenting information about the selected race events, a user interface or viewing race event information and placing wagers on an elected race event, a card read/write device for receiving an electronic or magnetic-stripe card encoded with a user's account information, a ticket dispensing device for providing a ticket comprising wager information for an elected race event and a stand-up type housing for retaining the display, the user interface, the card read/write device and the ticket dispensing device. The wagering terminal also includes a processor, as discussed above for facilitating wagering on race events. The wagering terminal may also include a speaker for playing audio associated with the wagering and race events information.

Preferably, the at least one wagering terminal according this embodiment is configured for providing a wager in only a single wager type, and the housing includes a wager description, prominently displayed on the housing, identifying the wager type using words which explain the wager type in simple betting terminology. For example, the at least one wagering terminal may be configured to provide a win, place, show, win-place-show (a win, place and show bet on a particular race contestant), exacta, triacta, superfecta, exacta and wheels, triacta and wheels and superfecta and wheels wager type. Example wager descriptions include “Pick a Winner”, “Pick Two Exact Order”, and “Pick Three Exact Order”. In an embodiment, the wager type of the at least one wagering terminal can be changed, for example, by manually configuring the at least one wagering terminal from one wager type (e.g., exacta) to another wager type (e.g., place) or by issuing a configuration change command from the race providing system to the at least one wagering terminal to cause the at least one wagering terminal to change from one wager type (e.g., exacta) to another wager type (e.g., place). Optionally, the configuration change command can be issued to the at least one wagering terminal that in its current configuration is able to process a wager type that is not available for a next race event (about which information is made available for display and wagering on the at least one wagering terminal).

The display comprises a CRT or other display for displaying information regarding the race events and ticker-tape type display for displaying select wagering information regarding the race events. Preferably, the CRT display comprises a touch-sensitive CRT display, including a touch-sensitive membrane in communication with the processor for “scrolling” between next and previous race events and race event tracks and for manually selecting race contestants for an elected race event. As will be apparent to those skilled in the art, any appropriate type of display may be used.

The user interface comprises a series of wager buttons 430, 440 for accepting wagers in certain wager (e.g., dollar) amounts and/or combinations. For example, a button may be engaged for a $1 wager amount and another button may be engaged for a $5 wager amount. The wager buttons may also represent certain wager combinations, e.g., exacta and 2 wheels. The user interface also includes a bet submission button for initiating transmission of a wager to the race providing system.

Turning to another embodiment, an at least one wagering terminal may comprise a display for presenting information about the selected race events, a user interface for viewing race event information and placing wagers on an elected race event, a card read/write device for receiving an electronic or magnetic-stripe card encoded with a user's account information, a ticket dispensing device for providing a ticket comprising wager information for an elected race event and a table-top type housing for retaining the display, the user interface, the card read/write device and the ticket dispensing device. The wagering terminal also includes a processor as discussed above for facilitating wagering on race events. The wagering terminal may also include a speaker (not shown) for playing audio associated with the wagering and race events information.

The display may comprises a CRT display for displaying information regarding the race events and preferably, the CRT display comprises a touch-sensitive CRT display, including a touch-sensitive membrane (not shown) in communication with the processor for selecting the desired wager type, for selecting the desired wager amount, for “scrolling” between next and previous race events and/or next and previous race event tracks, for manually selecting race contestants for an elected race event and for initiating transmission of a wager to the race providing system. As will be apparent to those skilled in the art, any appropriate type of display may be used.

Preferably, the at least one wagering terminal according to this embodiment is configured for providing a wager in a plurality of wager types, although as will be apparent it may be configured for a single wager type. Information presented on the display will facilitate easy selection of the wager type. For example, each time the user touches a portion of a touch-sensitive screen of the display associated with a button/icon to change the wager type of the at least one wagering terminal, the user scrolls through the various wager types offered by the at least one wagering terminal. Each time the user scrolls through the wager types offered by the at least one wagering terminal, the information regarding race events is presented according to the selected wager type. Alternatively, for example, the selection of the wager type may be performed by selecting a desired wager type in a menu presented on the display or by selection of icons corresponding to specific wager types offered by the at least one wagering terminal.

It should be understood that the configurations discussed are only an implementation for an at least one wagering terminal, and that other configurations are also envisaged. In a variation, not shown, the user interface includes a plurality of wager type buttons, each identifying a respective wager type (e.g., win, place, show, exacta, etc.), for facilitating placement of the wager according to one of a plurality of wager types.

In an embodiment of the at least one wagering terminal for a triacta wager type or the at least one wagering terminal capable of selection of a triacta wager type, a button and/or display icon may be provided for placing a $1 triacta wager amount for the three selected race contestants in the exact order as selected and another button and/or display icon may be provided for placing six $1 triacta wager amounts on the three selected race contestants in any order. Similarly, in an embodiment of the at least one wagering terminal for a superfecta wager type or the at least one wagering terminal capable of selection of a superfecta wager type, a button and/or display icon may be provided for placing a $1 superfecta wager amount for the four selected race contestants in the exact order as selected and another button and/or display icon may be provided for placing 24 $1 superfecta wager amounts on the four selected race contestants in any order.

In an embodiment of the at least one wagering terminal for an exacta and wheel wager type or the at least one wagering terminal capable of selection of an exacta and wheel wager type, a number of buttons and/or display icons may be provided for placing various combinations and amounts of wagers according to this wager type. For example, there may be provided a button and/or display icon for placing a $1 exacta wager amount for the two selected race contestants in the exact order as selected, a button and/or display icon for placing two $1 exacta wager amounts on the two selected race contestants in any order, a button and/or display icon for placing a $5 exacta wager amount for the two selected race contestants in the exact order as selected, a button and/or display icon for placing two $5 exacta wager amounts on the two selected race contestants in any order, a button and/or display icon for placing a $10 exacta wager amount for the two selected race contestants in the exact order as selected, and buttons and/or display icons each for placing X (where X is greater than or equal to two) number of $1 exacta and wheel wager amounts on the one selected exacta race contestant and the X selected wheel race contestants selected.

In another variation, the at least one wagering terminal may be a personal computer or a handheld device with all wagering functions provided on the display of the personal computer or handheld device for selection by use of a pointing device and/or designated keys on a keyboard associated with the personal computer or handheld device. In this variation, an electronic wager ticket mechanism may be provided in place of a physical wager ticket dispensing device. The electronic wager ticket mechanism would generate an electronic representation of the wager ticket that may be presented, for example, graphically on the display of the at least one wagering terminal. Further in this variation, a user may provide the relevant account information to the at least one wagering terminal instead of introducing an electronic or magnetic-stripe card to a card read/write device. For example, the user may manually enter the account information or employ any other electronic wallet or other automatic means for making the account information available to the wagering system. Many other variations of the wagering terminal will be apparent to those of ordinary skill in the art.

Another embodiment of a screen is a CRT display of a stand-up type on which there is at least one wagering terminal depicted. The screen depicts information regarding Race 1 at the Los Angeles horse race track. More particularly, race event track information (“Los Angeles”) and the race event number information (“Race 1”) are shown. The screen also depicts account balance information regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers.

Further, a number of horse head shaped icons, such as horse head icon, associated with the race contestants of the depicted race event are shown. Moreover, the race contestant start position information, such as race contestant start position information (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number may be presented on the display to indicate the selection of the race contestant and, where applicable, the race contestant's order in selection of a set of race contestants. In an embodiment, the user can clear the selected race contestant(s) using a “Clear Picks” button/icon in order to re-select one or more race contestants, as applicable, for a wager.

Further, the user may “scroll” through future race events at different race event tracks by touching the next and previous track buttons/icons, each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next and previous race buttons/icons, each touch of the icons causing the wagering processor to present, as applicable, updated information on the display corresponding to the “previous” or “next” race event by start time.

Another embodiment is for a screen on a CRT displaying at least one wagering terminal. The screen depicts information regarding Race 1 at the Los Angeles horse race track. More particularly, race event track information (“Los Angeles”) and the race event number information (“Race 1”) are examples of what could be shown. The screen also depicts account balance information regarding the current balance of the user of the at least one wagering terminal. In an embodiment, if the user has an insufficient account balance to wager (e.g., an account balance less than the minimum wager amount of the at least one wagering terminal), the account balance information blinks on the display to indicate an insufficient account balance. Further, the account balance information will automatically update to show credits from winning wagers of the user and, for effect, an alarm may sound for credits from winning wagers. Further, in an embodiment, a ticker-tape type display for displaying select wagering information regarding the race events, such as potential payouts for selected race event contestants for the current wager type depicted on the screen, is provided.

Further, a number of horse head shaped icons, such as horse head icon, associated with the race contestants of the depicted race event are shown. Moreover, the race contestant start position information, such as race contestant start position information (“1”), are associated with each icon so the user can know what race contestants to select. As is indicated on the screen, the user can select one or more race contestants, in accordance with a wager type, by touching the icons. Further, in an embodiment, each horse head icon has a differently shaded/color harness. As discussed above, the different shades/colors may be used to denote differing odds information associated with each race contestant. When a user selects a race contestant on the touch-sensitive display, the icon corresponding to that race contestant changes appearance to indicate the race contestant has been selected. For example, a pick number may be presented on the display to indicate the selection of the race contestant and, where applicable, the race contestant's order in selection of a set of race contestants. In an embodiment, the user can clear the selected race contestant(s) using a “Clear Picks” button/icon in order to re-select one or more race contestants, as applicable, for a wager.

Further, the user may “scroll” through future race events at different race event tracks by touching the next and previous track buttons/icons (not shown), each touch of the buttons/icons causing the wagering processor to present, as applicable, updated information on the display corresponding to a next race event by start time at “previous” or “next” race event tracks, whether for example a race event track by alphabetical order or a race event track having the next starting race event. Similarly, the user may “scroll” through future race events by starting time, whether for example at a selected race event track or across all race event tracks, by touching the next 735 and previous 740 race buttons/icons, each touch of the icons causing the wagering processor to present, as applicable, updated information on the display corresponding to the “previous” or “next” race event by start time.

As discussed above, in the tabletop type wagering terminal, the wager type presented on the display can be changed by the user by touching the “Change Game” button/icon. So, by using the “Change Game” button/icon, the user may change the display to present a “Win” wager type or scroll to any other wager type such as place, exacta, superfecta, etc. wager types offered by the at least one wagering terminal. For the “Win” wager type, for example, the screen comprises additional buttons/icons corresponding to the win wager type of the at least one wagering terminal to allow the user to select the wager amount (“$1”, “$5”, “$10”, “$20” buttons/icons) and to initiate the wager (“Play” button/icon). For other wager types, different additional buttons/icons may be provided as required by the particular wager type selected. As will be apparent to those skilled in the art, the wager type change feature may also be provided in the standup or any other type of display for the at least one wagering terminal.

A variation of the screen may also be used for a personal computer or handheld device variation of the at least one wagering terminal. In this variation, the screen could provide the ability for a user to enter account information (as discussed above) through, for example, the touching of a button/icon that initiates an account information entry dialog. Further, the screen or another screen could permit the user to view race event video corresponding to the race event displayed on the at least one wagering terminal. So, as the race event displayed on the at least one wagering terminal changes, the race event video would change to correspond to the displayed race event. Also, the screen could provide the display of information regarding electronic wager tickets (as discussed above) corresponding to wagers placed by the user of the at least one wagering terminal. For example, representations of unofficial electronic wager tickets corresponding to user wagers can be displayed at the bottom of the screen to show the outstanding user wagers. As the user's wagers become official, the representations of those unofficial electronic wager tickets could drop off the display at the bottom of the screen. Further, a monitor bets button/icon may be provided on the screen which allows the user to review the details of all unofficial and official electronic wager tickets.

Another form of wagering can be facilitated according to an embodiment of the invention. In this embodiment, the at least one wagering terminal is configured to provide a single wager type (although it may be reconfigured to a different wager type by a configuration change command). Where the at least one wagering terminal provides multiple wager types, the wagering facilitated by the wagering system according to that embodiment would query the user to select a particular wager type but would then operate according to the wagering described below. For example, the user interface may include a plurality of wager type buttons to allow the user to select a desired one of the wager types.

The account processor determines whether the user has introduced an electronic/magnetic-stripe card to the card read/write device and if so, establishes an account for the user in the account buffer if there is a credit in the account sufficient for the lowest wager amount available on the at least one wagering terminal and the card is otherwise operating properly. If the user has not introduced an electronic/magnetic-stripe card to the card read/write device, the account processor keeps determining whether a card has been introduced and the user will be unable to submit a wager or scroll through race events, e.g., the user interface is inactive, until a card is introduced. Optionally, the account processor may make available for display a warning to the user if the card is not operating properly, the user's account does not exist or there is an insufficient credit in the account. In an embodiment, the account processor of the at least one wagering terminal is configured to request from the user an appropriate password or other identification information via the user interface before establishing the account for the user in the account buffer. In an embodiment, a user may scroll through race events without having to introduce an electronic/magnetic-strip card to the card read/write device. In an embodiment, only the buttons/icons corresponding to wager amounts and combinations available for wagering in view of the balance available in the user's account and the particular race event displayed will be active. For example, available wager amount and combination buttons/icons are lighted or shown when the user has a sufficient balance for those wager amounts and/or the wager combination is possible at the displayed race event. Similarly, the inactive wager amount and combination buttons/icons are dark or not shown when the user has an insufficient balance for those wager amounts and/or the wager combination is not possible at the displayed race event.

Once a card is introduced, the race event selector of the at least one wagering terminal queries the racing information received from the race providing system, and identifies a next and other future race events, as described in more detail above, for display on the at least one wagering terminal via the wagering processor. At the outset and as the wagering pools associated with displayed race events close, the race event selector identifies a next race event for display on the at least one wagering terminal. As a user scrolls through race events by, for example, next or previous race event and/or race event track selection commands, the race event selector identifies other future race events for display on the at least one wagering terminal.

Thus, in an embodiment, a next race event is displayed on the at least one wagering terminal at the outset when a user introduces a card to the at least one wagering terminal. Thereafter, the user may scroll through race events and race events tracks but when the pool closes for a displayed race event, a further next race is displayed on the at least one wagering terminal. In essence, the race providing system provides a substantially continuous stream of racing information to the at least one wagering terminal in order to provide a substantially continuous display of information regarding a succession of race events. Further, the race providing system may also provide one or more sets of quick pick race contestant(s) as other information pertaining to the racing information in a substantially continuous fashion to the at least one wagering terminal and/or as requested by the at least one wagering terminal. Optionally, the at least one wagering terminal may receive a configuration change command to change the wager type assigned to the at least one wagering terminal.

The wagering processor makes available for display the information regarding the next and other future race event, particularly the race event track name and race event number, as identified or supplied by the race event selector. Particularly, the wagering processor makes available for display, as identified or supplied by the race event selector, next race events upon the introduction of a card to the at least one wagering terminal or as the pool for a displayed race event closes and next and other future race events scrolled through by the use of next and previous race events and race event tracks selection commands.

The wagering processor further makes available for display a number of icons corresponding to the race contestants in the displayed race event, including icons of varying shade/color to identify the different odds information associated with each race contestant. The wagering processor uses, for example, the odds information in the racing information buffer to assign varying shades/colors to the icons associated with each race contestant of the displayed race event.

The wagering processor also determines whether the user has activated a button/icon to scroll through race events and/or race event tracks i.e. the “Next Race”, “Previous Race”, “Next Track” or “Previous Track” buttons/icons. If so, the race event selector determines a next or other future race event for display and the wagering processor makes available for display information regarding the user elected next or other future race event, determined by the race event selector, resulting from the scrolling.

If an account is established, the wagering processor queries whether a wager amount has been selected (for example, via selection of one of the wager buttons). If not, the at least one wagering terminal continues to determine next and/or other future race events for display, display information regarding such race events, and present on the display information regarding elected next or other future race events resulting from the scrolling through race events and/or race event tracks. In an embodiment, the wagering processor employs a default wager amount, e.g., the lowest wager amount, when bet submission has been activated but no wager amount has been selected.

If a wager amount has been selected, the wagering processor waits for one or more race contestants to be selected by awaiting the activation of the bet submission button i.e. the “Play” button. For example, the race contestant(s) may be manually selected via touching a portion of a touch-sensitive screen of the display associated with the icon(s) of the selected race contestants (and then hits the “Play” button to submit the wager). If the user hits the “Play” button without selecting race contestants or only a partial number of the needed race contestants (not shown), the wagering processor queries the quick pick race contestant(s) buffer to derive a suitable set of quick pick race contestant(s) to complete the wager (as discussed in more detail above), in accordance with the wager type assigned to the at least one wagering terminal. If the user at any point touches a “Next Race”, “Previous Race”, etc. button/icon, the wagering is reset and the account processor waits for a new wager.

In a variation, the quick pick race contestant(s) selector is configured to determine a number of sets of quick pick race contestant(s) using a number of different race contestant selection algorithms. For example, a different race contestant selection algorithm may simply be a version of a race contestant selection algorithm giving different weights to handicapping and odds information or may be a race contestant selection algorithm using different handicapping information and/or odds information to select one or more race contestant(s). The quick pick race contestant(s) selector is configured to use a different race contestant selection algorithm whenever a reselection command is received from an at least one wagering terminal in order to provide one or more new sets of quick pick race contestant(s) to that wagering terminal.

The CPU is in communication with the system operator interface, the wagering terminal transceiver and the memory. The CPU facilitates the operation of the race providing system including executing processor instructions defining the quick pick race contestant(s) selector and the wager processor. The CPU also facilitates, where applicable, the determination of one or more least chosen race contestants for a wager type, particularly the one or more race contestants for a wager type that will yield a payout of the entire pool, as described in more detail below. Hotwalker Showdown Racing Challenge or Game uses a self-serve betting machine that has two modes of operation.

1. The first mode is where the player can choose his own
a. Race Track
b. Race Contestants
c. Dollar Amount
d. Bet Type
In any type of order

2. The second mode of operation is whereby the machine produces an Automated Pick whereby the race track, race contestants, dollar amount and bet type are chosen via a handicapping database that contains many variables, such as odds, medication, jockey weight, trainer stats, etc., basically any variable that could affect the outcome of a race. If the player selects his ticket manually by entering the four functions or steps into the machine as inputs to produce a race event ticket and if that respective ticket is a better selection than the automated selection or ticket, the player is entitled to a rebate in one embodiment of his or her bet. For example, if the player wagers a $100 on the 4^{th} race at Santa Anita on race contestant #5 to win and that race contestant wins paying $5 for a $2 ticket whereby the odds are 2½ to one or 5 to 2 and the database chooses race 4 at Suffolk Downs on race contestant #8 to show paying $3 for a $2 ticket which is 1½ to one or 3 to 2. In this showdown or challenge the player has defeated the machine and receives a 5% rebate or 5% return on his wager amount. IN this case, on a $100 wager he would receive $5 whereby the $5 would be coming out of the house or track commission. If the track receives a 10% commission on $100 wager translating into a $10 worth of takeout, half of the takeout or tax would be returned to the player since his or her $2 paid more based off of a $2 payout. One can view the rebate as insurance whereby the player can earn extra on top of the winnings which in turn neutralizes the losing tickets. If the player selects a losing ticket and database is also not successful than no rebate on the amount wagered is given. If the database or autopick ticket has a greater return than the manually player selected ticket on a minimum $1 or $2 return payout, then no rebate is rewarded to the player even though his ticket was still a winning ticket. For example, the database ticket paid $2.90 for a $1 wager and the input manually orchestrated ticket paid $2.80 for $1 wager than no rebate will be rewarded in this case since the player failed to beat the database.

One general way of describing a game that can be included within the player competition game of the present invention is as a method of providing a wagering event comprising: a player paying for at least one wager on a race event selected from the group consisting of a) a player selected wager and b) an automatically handicapped and selected wager, the player also receiving on the race event c) an automatically handicapped and selected wager when a) is selected or d) a player selected wager when b) is selected, the combination of selections a) and c) and selections b) and d) forming a special event wager, and after results of the race event, the player having the potential to receive an award dependent upon predetermined criteria having been met in results of the race event with respect to the special event wager. The player may pay for wager a) and receive selection c) without additional cost, or the player may pay for wager a) and receive selection c) with additional cost for wager c), either as a distinct and active wager or as a ghost wager used only in the special wager event. A ticket may contain both wagers, or each ticket may be coded (e.g., bar code or ticket identification code) so that the special event wager is unique to selections a), b), c) and/or d) for the individual player and players cannot “mix-and-match” different individually selected wagers and automatically selected wagers. The player may pay for wager a) and receive selection c) with additional cost for wager c) but without additional cost for entering a special event wagering game. The player may pay for wager b) and receive selection d) without additional cost or the player may pay for wager b) and receive selection d) with additional cost for wager d). The award may comprise a rebate or comp based on an amount paid by the player for a) or b). The predetermined criteria may require that at least a), b), c) or d) comprises a wager on a winning contestant(s) in the race event. The method may include that the predetermined criteria requires that the player selected wager outperforms the automatically handicapped and selected wager. For example, the predetermined criteria may require that the player selected wager outperforms the automatically handicapped and selected wager at least by a contestant(s) in the player selected wager finishing in the money and ahead of the contestant(s) in the automatically handicapped and selected wager.

A method according to the invention may also be described as providing a wagering event comprising: a player placing at least one wager through a wagering terminal on a race event selected from the group consisting of a) a player selected wager and b) an automatically handicapped and selected wager, the player also receiving on the race event c) an automatically handicapped and selected wager from a processor-based wagering system when a) is selected or d) a player selected wager when b) is selected, the combination of selections a) and c) and selections b) and d) forming a special event wager, and after results of the race event, the player having the potential to receive an award dependent upon predetermined criteria having been met in results of the race event with respect to the special event wager, the criteria comprising the player selected wager outperforming the automatically handicapped and selected wager. The criteria may require that both the player selected wager and the automatically handicapped and selected wager are winning events in race results on the race event.

The above gaming construction can use wagering games, wagering systems, wagering platforms and wagering terminals as described herein and as described in applications filed the same date as this application bearing Attorney's Docket Nos. 311.008US1 and 311.009US1 in the name of Andrew Stronach, which applications are incorporated herein in their entirety for the disclosure of wagering systems, apparatus, processes, software, hardware, wagering games and all other technical and business information.

The above description has used many specific examples and specific numbers in providing a non-limiting description of the invention. It should be apparent and is intended to be understood by those skilled in the art that alternatives to these specific examples may be used within the scope of the invention. The particular games and wagering systems described may be accessed, uploaded or downloaded on demand into terminals or PC's through information transmission (wired or wireless) to the wagering sites. This may be by I.P. broadcasting or multitasking with appropriate transmission security applied (e.g., encryption verification, encoding, secure lines, secure encoded signals, and the like. IP (Internet Protocol) is used to refer to a group of emerging, established and commercially available technologies that are reshaping the landscape of every industry involved with mass communications. Enabled by the IP concept, the Internet has emerged as a massive threat to TV, radio, cable, DBS and other broadcast distribution infrastructures. TCP and IP were developed by a Department of Defense (DOD) research project to connect a number of different networks designed by different vendors into a network of networks (the “Internet”). It was initially successful because it delivered a few basic services that everyone needed (file transfer, electronic mail, remote logon) across a large number of client and server systems. TCP/IP is composed of layers. IP is responsible for moving packets of data from node to node. IP forwards each packet based on a four-byte destination address (the IP number). The Internet authorities assign ranges of numbers to different organizations. The organizations assign groups of their numbers to departments. IP operates on gateway machines that move data from department to organization to region and then around the world. TCP is responsible for verifying the correct delivery of data from client to server, as data can be lost in the intermediate network. TCP adds support to detect errors or lost data and to trigger retransmission until the data is correctly and completely received.

TCP/IP is not a broadcast technology. It is a one-to-one packet-based communications protocol designed for the reliable delivery of data across interconnected networks. Digital broadcasting, on the other hand, is a one-to-many stream-based technology designed for the isochronous delivery of data across a variety of competing, largely non-interconnected networks. This is particularly applicable to wagering terminals where it is desirable to provide different wagering games to the terminals or to personal home computers or wagering sites.

Isochronous means that the data packets within a stream must be delivered on time and that the network must provide guaranteed bandwidth to support the peak bit-rate requirements of the content that is being delivered—typically audio and video streams. If the data does not arrive on time or it is corrupt, too bad—there are no second chances with real-time broadcast streams. This is uniquely critical in the wagering environment to have the information delivered in a timely manner. There are commercially available systems (e.g., SMPTE 259M (SDI) to move digital video through the routing switchers found in modern video facilities, and the MPEG-2 transport protocol is optimized for the delivery of compressed digital video streams) that are the transport layers of choice for digital cable, DBS and DTV broadcasting around the world. The benefit of IP Broadcasting is becoming obvious as the worlds of mass media broadcasting and the Internet collide. TCP/IP has become the language of peer-to-peer digital networking. It is found at the transport layer for the Ethernet networks that link computers together in offices and homes worldwide. And it is the transport layer for cable modems and digital subscriber lines, the broadband pipes that threaten to deliver mass media content on demand, to anyone, anywhere, anytime.

A number of safeguards and controls can be placed on the system of the invention to enhance security and compliance with State and National Laws and local gaming regulations. For example, it is important for the systems of the present invention to access and wager on races in multiple states, but wagers on races must be placed through in-State access ports, modules, exchanges, and other electronic or physical systems within the State to comply with local and State regulations. It would not be legal for a tipster to place the wager or for a walker in one State to actually place the wager in another state. This can be legally circumvented and all regulations and laws complied with according to a practice of the present invention. The walker or ticket promoter or tip provider promoting the automated wager and the automated wagering competition event has a portable telephone unit with direct line access or intermediate line access to the various state wagering pools, for example through a dedicated or available PBX (personal branch exchange). The system can be used to electronically place wagers on specific out-of-state race events by providing the player with direct usage, providing the player with a direct line to the out-of-state wagering site, or by providing a code or access number (internet, electronic or telephonic) so that the player places the wager. Electronic or internet or telephone access may be provided as part of the terminal itself or may be provided by the walker. For example, the player may communicate directly with the walker (the person providing the tip or automated wager suggestion or pick), even at a distal connection (which is the preferred embodiment), obtain the wagering information (the tip or automated wagering selection) and then be connected by the walker's system directly into the wagering outlet. In this way, the walker is a facilitator and does not actually place the wager. By placing the connection between the player and the wagering site through the walker's system, the wagers through that system can be tracked and the appropriate percentages from the pool paid to the walker's system.

An example of the operation of the system may be as follows. The player has registered with the walker system (a trade mark of “HOTWALKERS™” wagering system has been applied for. The player communicates directly with HOTWALKERS™ wagering system personnel, for example, a) by telephone, b) internet from home or public location, c) line connection from the wagering terminal, or other electronic or even direct verbal connection. The registered player obtains the desired wagering information and is then connected directly or indirectly to the wagering site to place a wager. By telephone, the call to the walker can be transferred through the PBX or other switching system (e.g., Ericsson Modular PBX; Nokia PBX; etc.) to an Interactive Voice Recognition system or Interactive Voice Responsive (IVR) system or Keypad Input Responsive system for placement of the wager. The HOTWALKER™ wagering system may have an interactive code so that all calls or connections made to the wagering site through the HOTWALKER™ wagering system are acknowledged, accounted for, registered, and identified for record-keeping purposes. The player may make the wager into the local wagering system. As the player is making the wager, this is a legal wager as long as the site from which the wager is being made is also a legal wagering jurisdiction.

Another set of systems can be used to assure or enforce compliance with jurisdictional wagering requirements. The phone calls can be identified by location of origin to the wagering site by either area codes (which would not work with cell phones that use their area code of registration from wherever the call is made, and so do not identify actual location of call origination) or by GPS tracking of the call (which will work with cell phones, as they can be tracked by Global Positioning Satellites). The telephone connection may have software that blocks specified area codes (where gaming or gambling is prohibited, such as Utah) or allows access to the wagering system from only area codes where gaming is allowed. Either confirmation of actual positioning may be required by GPS analysis, or when the call is identified as originating from a cell phone, GPS verification of location may be required.

An example of a direct transfer mechanism from the player to the HOTWALKER™ phone-in system to the wagering site could be as follows. The Player calls the HOTWALKER™ wagering system walker by telephone. An inquiry (with or without additional fee debiting) is made on a particular race and the information provided by the HOTWALKER™ wagering system personnel. The HOTWALKER™ wagering system personnel transfers the call (e.g., has a coded entry on the PBX or other call transferring system) directly to the wagering site, which preferably has an Interactive Voice Responsive capability or Interactive Keypad Responsive capability (that can be input through the telephone pad). The player, when connected to the wagering site then inputs the wager information to place the wager. The wager site identifies the location of the source of the wager by area code and/or GPS detection and fixing. The wager is then entered on the player's account in the HOTWALKER™ wagering system and/or the track site which accepts phone wagers, especially wagers identified by HOTWALKER™ wagering system coded entry or player account numbers and passwords. Player registration numbers on the HOTWALKER™ wagering system or in codes and passwords may require or desirably include area code identification numbers 9e.g., the area codes themselves) to provide an initial verification of a legal site source for the wager, with the actual area code phone verification (e.g., as is available on caller ID systems or other incoming call tracking systems) and/or GPS verification used in addition to preliminary screening of the incoming wagering calls.

The HOTWALKER™ wagering system personal identification numbers and passwords may be used to enter the wagers. These can be preprogrammed into information packets (e.g., automatic dialing) in the telephone calling system or added manually. Wagers placed through this system should be tracked and an accounting system set up for assuring credit for the HOTWALKER™ wagering system adding to the pool.

Although specific examples have been provided because of underlying legal requirements in this disclosure, alternative and equivalent materials and configurations can be used in the practice of the underlying invention.

1. A method of providing a wagering event comprising:
a player paying for at least one wager on a race event selected from the group consisting of a) a player selected wager and b) an automatically handicapped and selected wager,
the player also receiving on the race event c) an automatically handicapped and selected wager when a) is selected or d) a player selected wager when b) is selected, the combination of selections a) and c) and selections b) and d) forming a special event wager,
after results of the race event, the player having the potential to receive an award dependent upon predetermined criteria having been met in results of the race event with respect to the special event wager.

2. The method of claim 1 wherein the player pays for wager a) and receives selection c) without additional cost.

3. The method of claim 1 wherein the player pays for wager a) and receives selection c) with additional cost for wager c).

4. The method of claim 1 wherein the player pays for wager a) and receives selection c) with additional cost for wager c) but without additional cost for entering a special event wagering game.

5. The method of claim 1 wherein the player pays for wager b) and receives selection d) without additional cost.

6. The method of claim 1 wherein the player pays for wager b) and receives selection d) with additional cost for wager d).

7. The method of claim 1 wherein the award comprises a rebate or comp based on an amount paid by the player for a) or b).

8. The method of claim 2 wherein the award comprises a rebate or comp based on an amount paid by the player for a) or b).

9. The method of claim 3 wherein the award comprises a rebate or comp based on an amount paid by the player for a) or b).

10. The method of claim 1 wherein the predetermined criteria requires that at least c) or d) comprises a wager on a winning contestant(s) in the race event.

11. The method of claim 3 wherein the predetermined criteria requires that at least c) or d) comprises a wager on a winning contestant(s) in the race event.

12. The method of claim 6 wherein the predetermined criteria requires that at least c) or d) comprises a wager on a winning contestant(s) in the race event.

13. The method of claim 7 wherein the predetermined criteria requires that at least c) or d) comprises a wager on a winning contestant(s) in the race event.

14. The method of claim 1 wherein the predetermined criteria requires that the player selected wager outperforms the automatically handicapped and selected wager.

15. The method of claim 10 wherein the predetermined criteria requires that the player selected wager outperforms the automatically handicapped and selected wager.

16. The method of claim 1 wherein the predetermined criteria requires that the player selected wager outperforms the automatically handicapped and selected wager at least by a contestant(s) in the player selected wager finishing in the money and ahead of the contestant(s) in the automatically handicapped and selected wager.

17. The method of claim 2 wherein the predetermined criteria requires that the player selected wager outperforms the automatically handicapped and selected wager at least by a contestant(s) in the player selected wager finishing in the money and ahead of the contestant(s) in the automatically handicapped and selected wager.

18. The method of claim 3 wherein the predetermined criteria requires that the player selected wager outperforms the automatically handicapped and selected wager at least by a contestant(s) in the player selected wager finishing in the money and ahead of the contestant(s) in the automatically handicapped and selected wager.

19. The method of claim 5 wherein the predetermined criteria requires that the player selected wager outperforms the automatically handicapped and selected wager at least by a contestant(s) in the player selected wager finishing in the money and ahead of the contestant(s) in the automatically handicapped and selected wager.

20. The method of claim 6 wherein the predetermined criteria requires that the player selected wager outperforms the automatically handicapped and selected wager at least by a contestant(s) in the player selected wager finishing in the money and ahead of the contestant(s) in the automatically handicapped and selected wager.

21. A method of providing a wagering event comprising:
a player placing at least one wager through a wagering terminal on a race event selected from the group consisting of a) a player selected wager and b) an automatically handicapped and selected wager,
the player also receiving on the race event c) an automatically handicapped and selected wager from a processor-based wagering system when a) is selected or d) a player selected wager when b) is selected, the combination of selections a) and c) and selections b) and d) forming a special event wager,
after results of the race event, the player having the potential to receive an award dependent upon predetermined criteria having been met in results of the race event with respect to the special event wager, the criteria comprising the player selected wager outperforming the automatically handicapped and selected wager.

22. The method of claim 21 wherein the criteria requires that both the player selected wager and the automatically handicapped and selected wager are winning events in race results on the race event.

23. A method of placing wagers on racing event(s) comprising:
a player electronically or telephonically accessing communication with an intermediate;
the player receiving wagering information or wagering instructions from the intermediate;
the intermediate transferring the communication to a wagering site;
the player identifying the player to the wagering site;
the player placing a wager to the wagering site.

24. The method of claim 23 wherein the communication is analyzed for location source of the player communication.

25. The method of claim 24 wherein certain location sources are refused service to place a wager or only certain location sources are allowed service to place a wager.

26. The method of claim 24 wherein telephone area codes of the location source are used to determine if service is available for placement of a wager.

27. The method of claim 25 wherein telephone area codes of the location source are used to determine if service is available for placement of a wager.

28. The method of claim 23 wherein global positioning tracking of the location source are used to determine if service is available for placement of a wager.

29. The method of claim 24 wherein global positioning tracking of the location source are used to determine if service is available for placement of a wager.

30. The method of claim 25 wherein global positioning tracking of the location source are used to determine if service is available for placement of a wager.

31. The method of claim 27 wherein global positioning tracking of the location source are used to determine if service is available for placement of a wager.
